(19) United States
(12) Patent Application Publication
(10) Pub. No.: US 2026/0247268 A1
(43) Pub. Date: Aug. 20, 2026

(54) METHOD, DEVICE, AND MEDIUM FOR NETWORK SLICE SELECTION BASED ON SELECTION CRITERIA INFORMATION ELEMENT

(71) Applicant: Verizon Patent and Licensing Inc., Basking Ridge, NJ (US)

(72) Inventors: Lixia Yan, Basking Ridge, NJ (US); Violeta Cakulev, Millburn, NJ (US); Hossein M. Ahmadi, Parsippany, NJ (US); Ali Imdad Malik, East Brunswick, NJ (US)

(21) Appl. No.: 19/058,728

(22) Filed: Feb. 20, 2025

(51) Int. Cl. H04W 48/18; H04W 8/18; H04W 48/16

(52) U.S. Cl. CPC H04W 48/18; H04W 8/18; H04W 48/16

(57) ABSTRACT

A method, a network device, and a non-transitory computer-readable storage medium are described in relation to a network slice selection service. The network slice selection service may enable selection of a network slice identifier when a session request from an end device does not indicate a network slice identifier. The network slice selection service may include subscription data that includes criteria data and correlated network slice identifiers which may be used to select a network slice for the session request. The criteria data may indicate a configurable criterion, such as a time period, a priority value, metrics, or a sub-combination thereof. The subscription data may be implemented as session management subscription data or session management function selection subscription data.

### BACKGROUND

Development and design of networks present certain challenges from a network-side perspective and an end device perspective. For example, the network may be configured with network slices that enable end devices to access and use application services afforded specified quality of service. The selection, use, and management of network slices can present certain complexities relating to network resource utilization, end device subscription factors, adherence to service level agreements (SLAs), and so forth.

### BRIEF DESCRIPTION OF THE DRAWINGS

FIG. 1 is a diagram illustrating an exemplary environment in which an exemplary embodiment of a network slice selection service may be implemented;

FIG. 2 is an exemplary messaging diagram illustrating an exemplary process of an exemplary embodiment of the network slice selection service;

FIG. 3 is an exemplary messaging diagram illustrating another exemplary process of an exemplary embodiment of the network slice selection service;

FIG. 4 is a diagram illustrating exemplary components of a device that may correspond to one or more of the devices illustrated and described herein;

FIG. 5 is a flow diagram illustrating an exemplary process of an exemplary embodiment of the network slice selection service; and

FIG. 6 is a flow diagram illustrating another exemplary process of an exemplary embodiment of the network slice selection service.

### DETAILED DESCRIPTION

The following detailed description refers to the accompanying drawings. The same reference numbers in different drawings may identify the same or similar elements. Also, the following detailed description does not limit the invention.

A packet data unit (PDU) session refers to a connection between a user equipment (UE) and a data network (DN). The PDU session is linked to a particular data network name (DNN) and a specific network slice. The UE may access the same DN via different network slices. Typically, when the UE is in 5G coverage, the UE specifies the DNN and the network slice (e.g., a single network slice selection assistance information (S-NSSAI)) during a PDU session establishment procedure.

However, there may be instances that the UE does not indicate an S-NSSAI during the PDU session establishment procedure because it is not mandatory according to network standards, such as Third Generation Partnership Project (3GPP), 3GPP2, International Telecommunication Union (ITU), European Telecommunications Standards Institute (ETSI), GSM Association (GSMA), or the like. As a result, a 5G core network and associated 5G core devices, such as an access and mobility management function (AMF) among other 5G core devices, do not know which network slice should be used to support the PDU session. According to another example, when a UE establishes a packet data network (PDN) session in a Fourth Generation (4G) environment that is subsequently handed over to the 5G environment, a similar situation arises in that the 5G core network and associated 5G core devices do not have guidance as to which network slice should be used to support the PDU session.

According to exemplary embodiments, a network slice selection service is described. According to an exemplary embodiment, subscription data may include data indicating criteria for selecting a network slice and correlated network slice identifiers from which to select when a network slice identifier is not provided by an end device. According to an exemplary embodiment, the subscription data may indicate one or multiple network slice identifiers. According to an exemplary embodiment, the subscription data may be implemented as session management function (SMF) selection subscription data. According to another exemplary embodiment, the subscription data may be implemented as session management (SM) subscription data.

According to various exemplary embodiments, the criteria indicated in the subscription data may be time-based, priority-based, a combination thereof, analytics-based, such as a metric from a network data analytics function (NWDAF) (e.g., load-level (e.g., load level of a network device, such as an SMF), dispersion analytics (e.g., locations (e.g., cells, tracking area (TA), registration area (RA), etc.) where a UE or group of UEs disperse most), observed service experience, etc.), or another type of configurable criteria that may enable selection of a network slice identifier from among multiple candidate network slice identifiers.

According to various exemplary embodiments, the subscription data may be used for selecting a network slice identifier for non-roaming scenarios, such as PDU sessions originating in a home 5G environment, a 5G UE in 4G radio coverage in relation to a packet data network (PDN) session and a 5G environment, roaming scenarios (e.g., home, visitor, etc.), local breakout (LBO), and other types of contexts (e.g., a handover from a non-5G environment to a 5G environment, etc.), as described herein.

According to various exemplary embodiments, the network slice selection service may be configured with various core devices, such as an SMF, an AMF, a unified data management (UDM) device, and future generation core devices.

In view of the foregoing, the network slice selection service may enable selection of network slices identifiers and associated network slices in a more definitive manner based on the subscription data, as described herein. Additionally, the network slice selection service may provide flexibility to network operators and the like to configure network slice selection based on configurable criteria, as described herein. The network slice selection service may further improve PDU session establishment for end devices, mitigate network delays, and enable expedient network slice selection to occur when a session request, such as a PDU session establishment request or a packet data network (PDN) session establishment request does not include a network slice identifier.

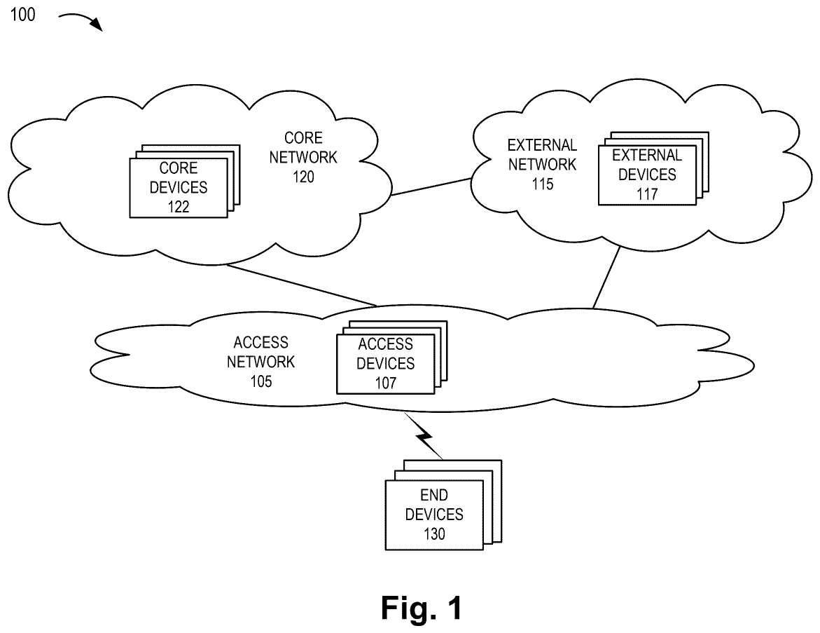

FIG. 1 is a diagram illustrating an exemplary environment 100 in which an exemplary embodiment of network slice selection service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7(SS 7 ), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the network slice selection service may use at least one of these planes. For example, the message of an exemplary embodiment of network slice selection service may use the control plane. According to various exemplary implementations, the interface of the network device may be an SBI, a reference point-based interface, an Open Radio Access Network (O-RAN) interface, a 5G interface, another generation of interface (e.g., 5G Advanced, Sixth Generation (6G), Seventh Generation (7G), Fourth Generation (4G), etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA, NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an EPC of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, an SMF, a UDM device, a unified data repository (UDR), an authentication server function (AUSF), a network slice selection function (NSSF), a network repository function (NRF), a policy control function (PCF), an NWDAF, a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the network slice selection service, as described herein. According to an exemplary embodiment, an AMF, an interworking MME/AMF, or a future generation core device that substantially performs similar functions as the AMF (referred to herein for purposes of brevity simply as an AMF) includes logic of an exemplary embodiment of the network slice selection service, as described herein. According to various exemplary embodiments, the AMF may provide the network slice selection service according to one or multiple contexts, such as non-roaming, roaming, LBO, handover, etc., as described herein.

According to an exemplary embodiment, the network slice selection service logic of the AMF may be invoked as a part of a session establishment procedure in which end device 130 does not indicate a network slice identifier (e.g., S-NSSAI) for establishing a session, such as omitting the S-NSSAI in a PDU session establishment request or another types of session request, in a 5G or a future generation network. The logic of the network slice selection service may include determining when the session establishment request does not include the S-NSSAI. In response, the AMF may use SMF selection subscription data to select a network slice identifier. According to an exemplary embodiment, the SMF selection subscription data may include network slice and criteria information, as described herein. According to an exemplary embodiment, the selected network slice identifier and associated network slice may be used for establishing the requested session.

According to another exemplary embodiment, an SMF, an interworking PGW-C/SMF, or a future generation core device that substantially performs functions of the SMF (referred to herein for purposes of brevity simply as an SMF) includes logic of an exemplary embodiment of the network slice selection service, as described herein. According to various exemplary embodiments, the SMF may provide the network slice selection service according to one or multiple contexts, such as non-roaming, roaming, LBO, handover, etc., as described herein.

According to an exemplary embodiment, the logic of the SMF may be invoked as a part of a session establishment procedure in which end device 130 does not indicate a network slice identifier (e.g., S-NSSAI) for establishing a session, such as omitting the S-NSSAI in a session establishment request or another types of session request, in a 5G or a future generation network. The logic of the network slice selection service may include determining when the session establishment request does not include the S-NSSAI. In response, the SMF may use SM subscription data to select a network slice identifier. According to an exemplary embodiment, the SM selection subscription data may include network slice and criteria information, as described herein. According to an exemplary embodiment, the selected network slice identifier and associated network slice may be used for establishing the requested session.

As previously described, the network slice selection service may provide subscription data that indicates one or multiple network slice identifiers, such as one or multiple S-NSSAIs, according to a configurable criteria or criterion. According to an exemplary embodiment, the criteria pertains to time. For example, one or multiple network slice identifiers may be indicated for selection according to a time parameter. By way of further example, the subscription data may indicate an S-NSSAI_1 that is mapped to a time period (e.g., start time_1−end time_1) and an S-NSSAI_2 that is mapped to another time period (e.g., start time_2−end time_2). For example, as illustrated below, a network slice criteria information element (IE), which may be included in SMF selection subscription data or SM subscription data may include the exemplary information:
Slice Selection Criteria {
Criteria type: Time Period
S-NSSAI: 1-0000007
   Start Time: 0800
   End Time: 1700
S-NSSAI: 1-0000006
   Start Time: 1700
   End Time: 0800
}

The format of the exemplary network slice criteria IE is exemplary as well as values included therein. As shown, the exemplary IE may include, among other data instances, criteria type, network slice identifiers and corresponding time periods during which the identified network slice identifiers may be selected. The number of time periods and the number of network slice identifiers associated with a given time period are exemplary. The network slice criteria IE may include other data, such as a DNN, etc.

According to another exemplary embodiment, the criteria pertains to two or more levels of priority. For example, an S-NSSAI_1 may have a priority level_1, an S-NSSAI_2 may have a priority level_2, and so forth. For example, as illustrated below, a network slice criteria IE, which may be included in SMF selection subscription data or SM subscription data may include the exemplary information:
Slice Selection Criteria {
Criteria type: Priority
DNN Name: Internet
   Priority 1:1-0000007,
   Priority 2:1-0000006
DNN Name: IMS
   Priority 1:1-0000008,
   Priority 2:1-0000009
}

The format of the exemplary network slice criteria IE is exemplary as well as values included therein. As shown, the exemplary IE may include, among other data instances, a DNN and corresponding network slice identifiers (e.g., 1-0000007, 1-0000006, etc.) that may correlate to or map to a given priority level value. For example, priority 1 may have a higher priority value than priority 2, and thus be subject to being selected first. The number and type of DNN names, the number of priority levels, and the number of network slice identifiers associated with a given DNN and priority level are exemplary.

According to still other exemplary embodiments, a combination of such criteria may be implemented (e.g., time and priority) or a different criterion (e.g., NWDAF metric), individually or in combination with another criterion may be utilized in relation to one or multiple network slice identifiers, as described herein.

According to an exemplary embodiment, the SMF selection subscription data, the SM selection subscription data, or both may include, in addition to the network slice and criteria information, other data instances that may be in accordance with a network standard (e.g., 3GPP, ITU, ETSI, etc.), of a proprietary nature, or both.

According to an exemplary embodiment, a UDM, an interworking HSS/UDM, or a future generation core device that performs a similar function as the UDM (referred to herein for purposes of brevity simply as a UDM), includes logic of an exemplary embodiment of the network slice selection service, as described herein. According to an exemplary embodiment, the logic of the UDM may store and manage the subscription data, and make such subscription data available to other core devices 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

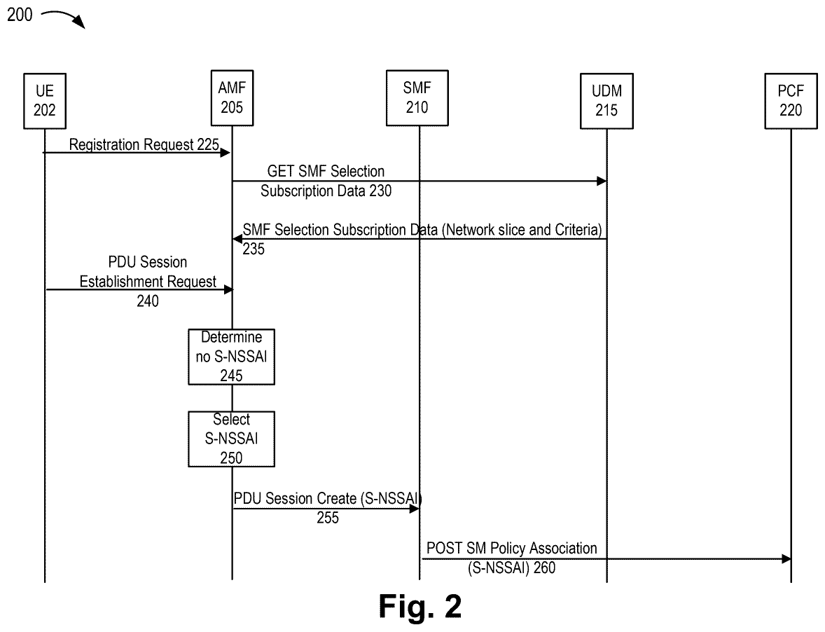

FIG. 2 is an exemplary messaging diagram illustrating an exemplary process 200 of an exemplary embodiment of the network slice selection service. As illustrated, process 200 may involve exemplary network devices, such as an AMF 205, an SMF 210, a UDM 215, and a PCF 220. Process 200 may further involve a UE 202, which is an exemplary implementation of end device 130. According to other exemplary embodiments, process 200 may involve fewer, different, or additional network devices.

The messages illustrated and described are exemplary. Additionally, any protocol suggested by the form of a message is purely exemplary and not intended to limit the embodiment of the network slice selection service. For example, some of the exemplary messages illustrated and described may include use of the Hypertext Transfer Protocol (HTTP) in which certain request methods (e.g., GET, POST, etc.) may be used. However, according to other exemplary embodiments, such messages may be implemented by a protocol other than HTTP or a version thereof.

For purposes of brevity and avoidance of obscuring aspects of the network slice selection service, some messages pertaining to initial registration and setup of a PDU session have been omitted. Accordingly, in practice, additional messages may be exchanged and additional core devices 122 may be involved in the initial registration procedure and PDU session establishment procedure.

Process 200 may pertain to a non-roaming scenario. However, according to other exemplary embodiments of the network slice selection service, modifications to process 200 may be implemented to accommodate home-routed roaming scenarios, roaming with LBO scenarios, and other types of contexts (e.g., handover, etc.).

AMF 205, SMF 210, UDM 215, PCF 220, and UE 202 may each include logic that performs an operation or provides a function that is in accordance with a technical specification associated with a network standardizing body, such as 3GPP, 3GPP 2, ITU, ETSI, GSMA, or the like. According to some exemplary embodiments, AMF 205, SMF 210, UDM 215, PCF 220, and UE 202, or a sub-combination thereof, may be configured with logic that provides a proprietary operation or function not specified by the network standard. Additionally, AMF 205, SMF 210, and UDM 215 may each include logic of the network slice selection service, as described herein.

Referring to FIG. 2, UE 202 may generate and transmit a non-access stratum (NAS) message, such as a registration request 225, to AMF 205 via a 5G RAN (not illustrated). Registration request 225 may include various parameters, such as UE identity, security parameters, UE capabilities, registration type, UE location, and so forth. As a part of the initial registration procedure, AMF 205 may generate and transmit a GET SMF selection subscription data 230 to UDM 215. According to an exemplary embodiment, the SMF selection subscription data may include one or multiple network slice identifiers (e.g., S-NSSAI(s)) that may be used for selection according to a configurable criteria, as described herein, when UE 202 does not include a network slice identifier in a session (establishment) request. In response, UDM 215 may retrieve and transmit SMF selection subscription data 235, which includes the network slice identifier information and criteria, as described herein. AMF 205 may store the SMF selection subscription data.

Subsequent to registration (and/or attachment), UE 202 may generate and transmit a PDU session establishment request 240 to AMF 205. PDU session establishment request 240 may include, among other data, a UE requested DNN, a PDU session identifier, a request type (e.g., initial, emergency, existing, etc.), a requested session and service continuity (SSC) mode, UE location, access type, and so forth. However, according to this exemplary scenario, PDU session establishment request 240 does not indicate a network slice (e.g., an S-NSSAI).

In response to receiving request 240, AMF 205 may read request 240 and determine 245 that no S-NSSAI is indicated in request 240. In response, AMF 205 may analyze the SMF selection subscription data 235 and select 250 S-NSSAI. For example, AMF 205 may select an S-NSSAI according to a criterion associated with one or multiple S-NSSAIs. AMF 205 may select the S-NSSAI based on other information, in addition to the SMF selection subscription data, such as allowed NSSAI for end device 130, the DNN, and a metric from an NWDAF, or a sub-combination thereof, for example.

According to various exemplary embodiments, the network slice and criteria information may include one or multiple criteria in which each criterion may be associated with one or multiple S-NSSAIs. For example, AMF 205 may omit selecting any S-NSSAI associated with a first criteria (e.g., priority or another type of criteria) when the S-NSSAI(s) are not within the allowed NSSAI or not permissible in view of the DNN. According to such an exemplary, AMF 205 may select an S-NSSAI associated with a second criteria (e.g., time or another type of criteria), which differs from the first criteria, that may be permissible in view of the allowed NSSAI, the DNN, etc. According to another example, the network slice and criteria information may include a single criteria and one or multiple S-NSSAIs. According to an exemplary scenario, AMF 205 may apply the criterion (e.g., priority, time, etc.) and select an S-NSSAI, which may also be within the allowed NSSAI for UE 202, permissible in view of the DNN, and so forth.

Based on the selection of the S-NSSAI, AMF 205 may generate and transmit a PDU session create message 255, which includes the selected S-NSSAI, to SMF 210. In response, SMF 210 may perform an SM policy association establishment procedure with PCF 220, which may include generating and transmitting a POST SM policy association message 260, which includes the selected S-NSSAI, among other types of information, such as the DNN, etc. Thereafter, although, not illustrated, a PDU session may be established using the selected network slice.

FIG. 2 illustrates an exemplary process 200, however, according to other exemplary embodiments and scenarios, process 200 may include additional operations or fewer operations, and different operations, or a sub-combination thereof, and/or additional messages or fewer messages, and different messages, or a sub-combination thereof, depending on the context.

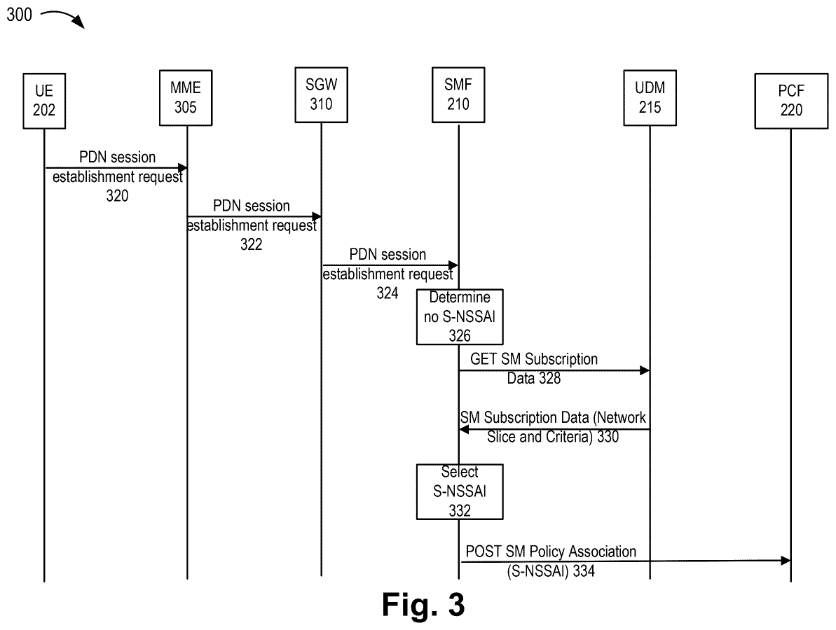

FIG. 3 is an exemplary messaging diagram illustrating an exemplary process 300 of an exemplary embodiment of the network slice selection service. As illustrated, process 300 may involve exemplary network devices, such as SMF 210, UDM 215, and PCF 220, which have been previously described, and UE 202, which is an exemplary implementation of end device 130. As further illustrated, process 300 may further involve an MME 305 and an SGW 310. According to other exemplary embodiments, process 300 may involve fewer, different, or additional network devices. For example, process 300 may involve a 4G RAN device, such as an eNB or the like.

The messages illustrated and described are exemplary. Additionally, any protocol suggested by the form of a message is purely exemplary and not intended to limit the embodiment of the network slice selection service. For example, some of the exemplary messages illustrated and described may include use of the Hypertext Transfer Protocol (HTTP) in which certain request methods (e.g., GET, POST, etc.) may be used. However, according to other exemplary embodiments, such messages may be implemented by a protocol other than HTTP or version thereof.

For purposes of brevity and avoidance of obscuring aspects of the network slice selection service, some messages pertaining to the setup of a session have been omitted. Accordingly, in practice, additional messages may be exchanged and additional core devices 122 may be involved in the session establishment procedure.

MME 305 and SGW 310 may include logic that performs an operation or provides a function that is in accordance with a technical specification associated with a network standardizing body, such as 3GPP, 3GPP 2, ITU, ETSI, GSMA, or the like.

Process 300 may pertain to a non-roaming scenario in which UE 202 may be a 5G device that is situated in an LTE/4G radio coverage area. However, according to other exemplary embodiments of the network slice selection service, modifications to process 300 may be implemented to accommodate home-routed roaming scenarios, roaming with LBO scenarios, and other types of contexts (e.g., handover, etc.).

Referring to FIG. 3, UE 202 may generate and transmit a PDN session establishment request 320 to MME 305 via a 4G RAN device (not illustrated), such as an eNB, etc. In view of the LTE/4G framework, PDN session establishment request 320 may not indicate an S-NSSAI. In response, MME 305 and SGW 310 may each forward (or generate a new) PDN session establishment requests 322 and 324, respectively to SMF 210.

In response to receiving and reading request 324, SMF 210 may determine that request 324 is a PDN request and not a PDU request, and may also determine 326 that an S-NSSAI is not provided by UE 202 and/or not included in request 322. Based on the receipt of request 324, SMF 210 may generate and transmit a GET SM subscription data 328 to UDM, and in response receive from UDM 215, SM subscription data 330, which includes network slice and criteria information, as described herein. In response to receiving SM subscription data 330, SMF 210 may read and analyze the SM subscription data and associated criteria to select 332 the appropriate S-NSSAI. SMF 210 may select the S-NSSAI based on other information, in addition to the SM subscription data, such as allowed NSSAI for UE 202, the DNN, and a metric from an NWDAF, or a sub-combination thereof, for example.

Based on the selection of the S-NSSAI, SMF 210 may perform an SM policy association establishment procedure with PCF 220, which may include generating and transmitting a POST SM policy association message 334, which includes the selected S-NSSAI, among other type of information, such as the DNN, etc. Thereafter, although not illustrated, core devices 122 of the 5G core network may establish use of a network slice associated with the selected network slice identifier for a portion of the end-to-end connection between UE 202 and the DNN. For example, the network slice may include a network connection from a UPF to the DN (not illustrated).

FIG. 3 illustrates an exemplary process 300, however, according to other exemplary embodiments and scenarios, process 300 may include additional operations, fewer operations, and/or different operations.

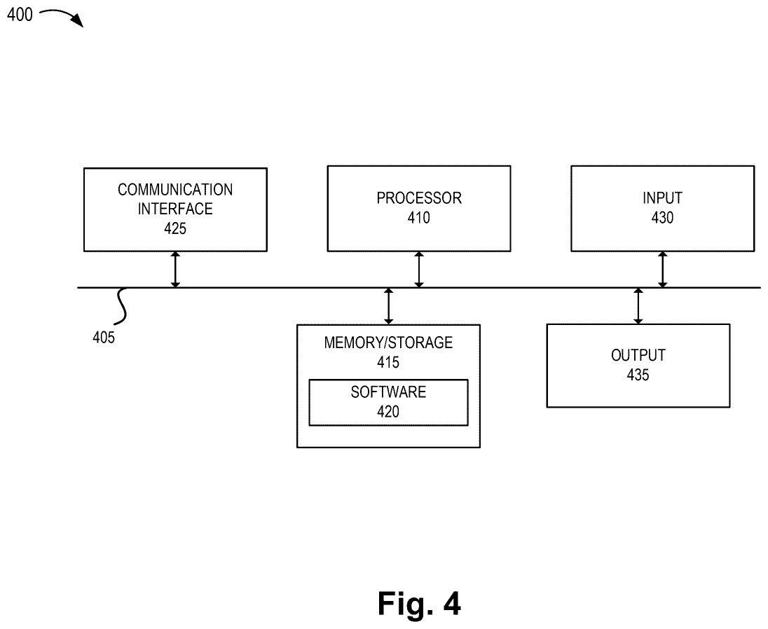

FIG. 4 is a diagram illustrating exemplary components of a device that may correspond to one or more of the devices illustrated and described herein. For example, device 400 may correspond to access device 107, external device 117, core device 122, end device 130, AMF 205, SMF 210, UDM 215, PCF 220, MME 305, SGW 310, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques and/or technologies including, for example, multithreading, parallel processing, pipelining, interleaving, machine learning, artificial intelligence, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, a solid state drive, mass storage, off-line storage, cloud storage, or some other type of storing medium. Memory/storage 415 may store data, software, and/or instructions related to the operation of device 400.

Software 420 includes an application or a program that provides a function and/or a process. As an example, with reference to AMF 205, software 420 may include an application that, when executed by processor 410, provides a function and/or a process of network slice selection service, as described herein. Additionally, with reference to SMF 210, UDM 215, and/or other core devices 122, software 420 may include an application that, when executed by processor 410, configures processor 410 to provide a function and/or a process of the network slice selection service or supports the process of the network slice selection service, as described herein. Software 420 may also include firmware, middleware, microcode, hardware description language (HDL), and/or other form of instruction. Software 420 may also be virtualized. Software 420 may further include an operating system.

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions that are stored by memory/storage 415 may configure and cause processor 410 to perform a function or a process described herein. Alternatively, for example, according to other implementations, device 400 performs a function or a process described herein based on the execution of hardware (processor 410, etc.).

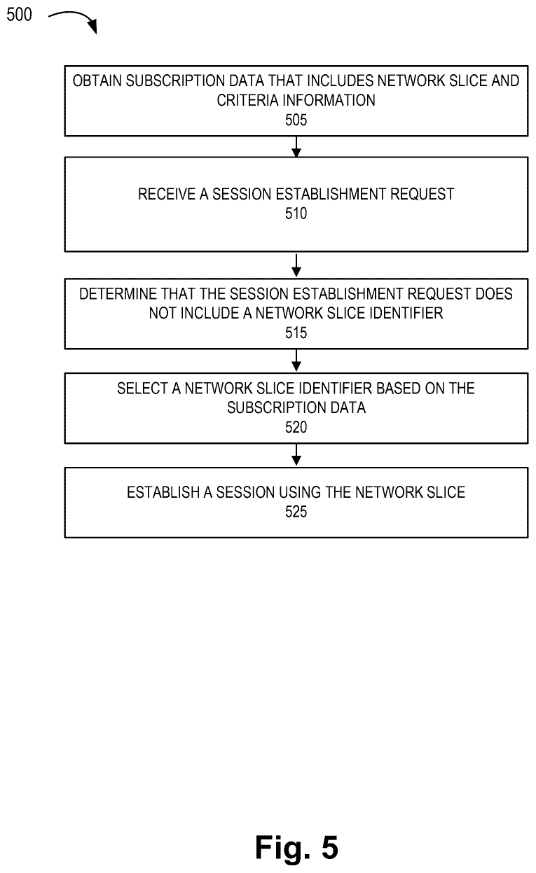

FIG. 5 is a flow diagram illustrating an exemplary process 500 of an exemplary embodiment of the network slice selection service. According to an exemplary embodiment, core device 122, such as AMF 205 may perform a step of process 500. According to an exemplary implementation, processor 410 executes software 420 to perform a step of process 500, as described herein. Alternatively, a step may be performed by execution of only hardware.

In block 505, AMF 205 may obtain subscription data that includes network slice and criteria information, as described herein. For example, the subscription data is SMF selection subscription data. According to an exemplary embodiment, the network slice and criteria information may include one or multiple criterion and corresponding one or multiple network slice identifiers (e.g., one or multiple S-NSSAIs) for each criterion, as described herein. According to an exemplary embodiment, AMF 205 may obtain the subscription data from a UDM, such as UDM 215, as a part of an initial registration procedure with end device 130. AMF 205 may store the SMF selection subscription data.

In block 510, AMF 205 may receive a session establishment request. For example, the session establishment request may be a PDU session establishment request. AMF 205 may receive the PDU session establishment request from end device 130 via access device 107.

In block 515, AMF 205 may determine that the session establishment request does not include a network slice identifier. For example, AMF 205 may read the PDU session establishment request and determine that end device 130 did not include an S-NSSAI.

In block 520, AMF 205 may select a network slice identifier based on the subscription data. For example, AMF 205 may apply a given criteria of the network slice and criteria information and select a network slice identifier to be used for the prospective PDU session associated with the PDU session establishment request. As previously described, AMF 205 may apply other information and/or analytics to select the network slice, such as the DNN, allowed NSSAI of end device 130, load criteria, etc.

In block 525, AMF 205 may establish a session using the network slice. For example, AMF 205 may communicate a message, with other core devices 122 of the control plane, to establish the PDU session via the network slice identified by the selected network slice identifier, as described herein. By way of further example, AMF 205 may transmit a PDU session create message, which includes the selected S-NSSAI, to SMF 210. AMF 205 may subsequently perform other operations and communicate other messages in support of the PDU session establishment in accordance with a network standard, for example. End device 130 may conduct a PDU session via the selected network slice.

FIG. 5 illustrates an exemplary process 500 of the network slice selection service, according to other exemplary embodiments, the network slice selection service may perform additional operations, fewer operations, and/or different operations than those illustrated and described.

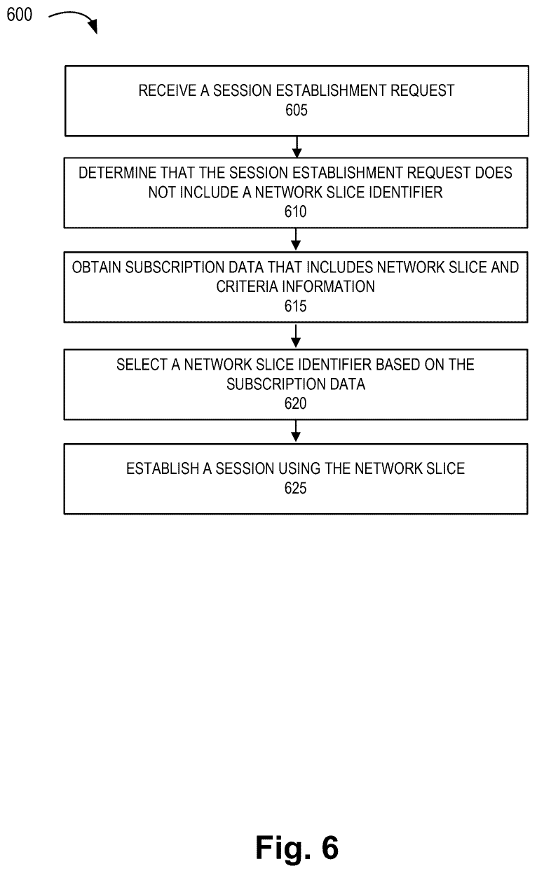

FIG. 6 is a flow diagram illustrating an exemplary process 600 of an exemplary embodiment of the network slice selection service. According to an exemplary embodiment, core device 122, such as SMF 210 may perform a step of process 600. According to an exemplary implementation, processor 410 executes software 420 to perform a step of process 600, as described herein. Alternatively, a step may be performed by execution of only hardware.

In block 605, SMF 210 may receive a session establishment request. For example, SMF 210 may receive a PDN session establishment request. According to an exemplary embodiment, SMF 210 may receive the PDN session establishment request via a 4G RAN and 4G core device 122 (e.g., MME 305, SGW 310), as described herein.

In block 610, SMF 210 may determine that the session establishment request does not include a network slice identifier. For example, SMF 210 may read the PDN session establishment request and determine that a network slice identifier is not provided.

In block 615, SMF 210 may obtain subscription data that includes network slice and criteria information. For example, SMF 210 may obtain SM subscription data from a UDM, such as UDM 215. SMF 210 may store the SM subscription data.

In block 620, SMF 210 may select a network slice identifier based on the subscription data. For example, SMF 210 may read and analyze the SM subscription data, which includes the network slice and criteria information, and select an S-NSSAI. SMF 210 may select the S-NSSAI based on other information, in addition to the SM subscription data, such as allowed NSSAI for end device 130, the DNN, and a metric from an NWDAF, or a sub-combination thereof, for example.

In block 625, SMF 210 may establish a session using the network slice. For example, SMF 210 may communicate a message, with other core devices 122 of the control plane, to establish the PDU session via the network slice identified by the selected network slice identifier, as described herein. By way of further example, SMF 210 may perform an SM policy association procedure with a PCF, such as PCF 220, which accounts for the selected S-NSSAI. SMF 210 may subsequently perform other operations and communicate other messages in support of the PDU session establishment in accordance with a network standard, for example. End device 130 may conduct a PDU session via the selected network slice.

FIG. 6 illustrates an exemplary process 600 of the network slice selection service, according to other exemplary embodiments, the network slice selection service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while series of blocks have been described regarding the processes illustrated in FIGS. 5 and 6, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
obtaining, by a network device of a core network, session management function (SMF) selection subscription data that includes network slice identifiers and criteria for selecting the network slice identifiers;
receiving, by the network device from an end device, a request to establish a packet data unit (PDU) session;
determining, by the network device, that the request does not indicate a network slice identifier;
selecting, by the network device, one of the network slice identifiers based on the criteria; and
establishing, by the network device, the PDU session based on the one of the network slice identifiers.

2. The method of claim 1, wherein the criteria includes time periods that correlate to the network slice identifiers.

3. The method of claim 1, wherein the criteria includes priority values that correlate to the network slice identifiers.

4. The method of claim 1, wherein the selecting further comprises:
selecting, by the network device, the one of the network slice identifiers based on one or more of a data network name (DNN) or a load level.

5. The method of claim 1, wherein the establishing further comprises:
transmitting, by the network device to an SMF, a message that includes the one of the network slice identifiers.

6. The method of claim 1, wherein the selecting further comprises:
selecting, by the network device, the one of the network slice identifiers based on one or more of dispersion analytics or allowed network slice selection assistance information (NSSAI) pertaining to the end device.

7. The method of claim 1, wherein the criteria includes time periods and priority values that correlate to the network slice identifiers.

8. The method of claim 1, wherein the network device is an access and mobility management function (AMF) or a future generation AMF.

9. A network device comprising:
a processor that is configured to:
obtain session management function (SMF) selection subscription data that includes network slice identifiers and criteria for selecting the network slice identifiers;
receive, from an end device, a request to establish a packet data unit (PDU) session;
determine that the request does not indicate a network slice identifier;
select one of the network slice identifiers based on the criteria; and
establish the PDU session based on the one of the network slice identifiers.

10. The network device of claim 9, wherein the criteria includes time periods that correlate to the network slice identifiers.

11. The network device of claim 9, wherein the criteria includes priority values that correlate to the network slice identifiers.

12. The network device of claim 9, wherein when selecting, the processor is further configured to:
select the one of the network slice identifiers based on one or more of a data network name (DNN) or a load level.

13. The network device of claim 9, wherein the processor is further configured to:
transmit, to an SMF, a message that includes the one of the network slice identifiers.

14. The network device of claim 9, wherein when selecting, the processor is further configured to:
select the one of the network slice identifiers based on one or more of dispersion analytics or allowed network slice selection assistance information (NSSAI) pertaining to the end device.

15. The network device of claim 9, wherein the criteria includes time periods and priority values that correlate to the network slice identifiers.

16. The network device of claim 9, wherein the network device is an access and mobility management function (AMF) or a future generation AMF.

17. A non-transitory computer-readable storage medium storing instructions executable by a processor of a network device, wherein the instructions are configured to:
obtain session management function (SMF) selection subscription data that includes network slice identifiers and criteria for selecting the network slice identifiers;
receive, from an end device, a request to establish a packet data unit (PDU) session;
determine that the request does not indicate a network slice identifier;
select one of the network slice identifiers based on the criteria; and
establish the PDU session based on the one of the network slice identifiers.

18. The non-transitory computer-readable storage medium of claim 17, wherein the instructions are further configured to:
select the one of the network slice identifiers based on one or more of dispersion analytics or allowed network slice selection assistance information (NSSAI) pertaining to the end device.

19. The non-transitory computer-readable storage medium of claim 17, wherein the criteria includes time periods that correlate to the network slice identifiers.

20. The non-transitory computer-readable storage medium of claim 17, wherein the criteria includes time periods and priority values that correlate to the network slice identifiers.
